(19) United States
(12) Patent Application Publication
(10) Pub. No.: US 2024/0375401 A1
(43) Pub. Date: Nov. 14, 2024

(54) HEAD UNIT AND LIQUID EJECTING APPARATUS

(71) Applicant: SEIKO EPSON CORPORATION, Tokyo (JP)

(72) Inventors: Takeshi OWAKU, AZUMINO-SHI (JP); Keita MORIYAMA, MATSUMOTO-SHI (JP)

(21) Appl. No.: 18/661,248

(22) Filed: May 10, 2024

(30) Foreign Application Priority Data
May 12, 2023 (JP) 2023-079193

(51) Int. Cl. B41J 2/155; B41J 2/165

(52) U.S. Cl. CPC B41J 2/155; B41J 2/15; B41J 2/16538

(57) ABSTRACT

There is provided a head unit configured to eject a liquid to a medium while reciprocating along a second axis that is perpendicular to a first axis along a transport direction of the medium. The head unit includes a plurality of liquid ejecting heads including first head configured to eject a first liquid, a reaction liquid head configured to eject a reaction liquid that aggregates the first liquid, and treatment liquid head configured to eject a treatment liquid containing a softening agent. The first head and the reaction liquid head are adjacent to each other and are arranged along the second axis. The treatment liquid head is arranged with the first head along the first axis.

The present application is based on, and claims priority from JP Application Serial Number 2023-079193, filed May 12, 2023, the disclosure of which is hereby incorporated by reference herein in its entirety.

### BACKGROUND

### 1. Technical Field

The present disclosure relates to a head unit including a liquid ejecting head that ejects a liquid, and a liquid ejecting apparatus including the head unit.

### 2. Related Art

In the related art, a liquid ejecting head having a nozzle row for ejecting a liquid such as an ink to a medium such as cloth or paper is known. In order to improve the fixability of a liquid to a medium, for example, JP-A-10-193579 discloses a liquid ejecting head that ejects a liquid such as ink and a reaction liquid containing an aggregating agent for aggregating the liquid.

However, in JP-A-10-193579 described above and the like, fine mist is generated when the reaction liquid is ejected. The mist adheres to a nozzle that ejects a liquid such as an ink and the periphery of the nozzle, and thus the liquid in the vicinity of the nozzle aggregates. Due to the aggregate, the ejection failure such as clogging of the nozzle or shift of a flight direction of the liquid may occur.

### SUMMARY

According to an aspect of the present disclosure, there is provided a head unit that ejects a liquid to a medium while reciprocating along a second axis that is perpendicular to a first axis along a transport direction of the medium. The head unit includes a plurality of liquid ejecting heads including a first head that ejects a first liquid, a reaction liquid head that ejects a reaction liquid that aggregates the first liquid, and a treatment liquid head that ejects a treatment liquid containing a softening agent. The first head and the reaction liquid head are adjacent to each other and are arranged along the second axis, and the treatment liquid head is arranged with the first head along the first axis.

According to another aspect of the present disclosure, there is provided a liquid ejecting apparatus including the head unit according to the above aspect, and a wiping member that wipes an ejection surface of the treatment liquid head and an ejection surface of the first head along the first axis in this order.

### BRIEF DESCRIPTION OF THE DRAWINGS

FIG. 1 is a view illustrating a schematic configuration of a liquid ejecting apparatus according to a first embodiment.

FIG. 2 is an exploded perspective view of a head unit according to the first embodiment.

FIG. 3 is a plan view of the head unit according to the first embodiment.

FIG. 4 is an exploded perspective view of a liquid ejecting head according to the first embodiment.

FIG. 5 is a plan view of the liquid ejecting head according to the first embodiment.

FIG. 6 is a cross-sectional view of the liquid ejecting head according to the first embodiment.

FIG. 7 is a cross-sectional view of the head chip according to the first embodiment.

FIG. 8 illustrates a correspondence table between disposition of the liquid ejecting head and a liquid to be ejected, according to the first embodiment.

FIG. 9 is a plan view of a head unit according to a second embodiment.

FIG. 10 illustrates a correspondence table between disposition of a liquid ejecting head and a liquid to be ejected, according to the second embodiment.

### DESCRIPTION OF EMBODIMENTS

Hereinafter, the present disclosure will be described in detail based on embodiments. However, the following description illustrates an aspect of the present disclosure, and can be freely changed within the scope of the present disclosure. Those having the same reference signs in each of the drawings indicate the same members, and the description thereof is omitted as appropriate. In each of the drawings, X, Y, and Z represent three spatial axes perpendicular to each other. In the present specification, directions along these axes are set as an X-direction, a Y-direction, and a Z-direction. A direction where the arrow in each of the drawings is directed is a positive (+) direction, and a direction opposite to the arrow is a negative (−) direction. In addition, the directions of three spatial axes that do not limit the positive direction and the negative direction will be described as the X-axis direction, the Y-axis direction, and the Z-axis direction.

### First Embodiment

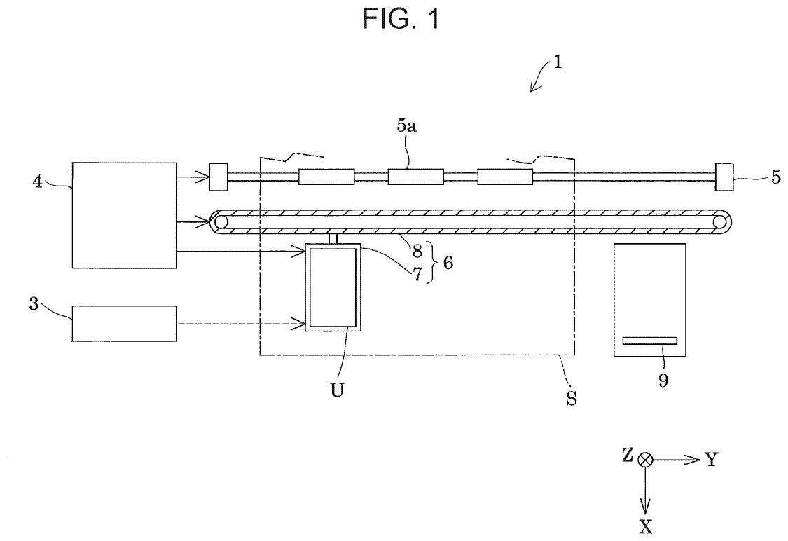

FIG. 1 is a view illustrating a schematic configuration of a liquid ejecting apparatus 1 according to a first embodiment of the present disclosure.

As illustrated in FIG. 1, the liquid ejecting apparatus 1 includes a head unit U including a plurality of liquid ejecting heads H. The liquid ejecting apparatus 1 is a so-called serial type printer that performs printing by transporting a medium S in the X-axis direction and ejecting a liquid from the liquid ejecting head H to the medium S in the +Z direction while reciprocating the head unit U in the Y-axis direction. As the medium S, any material such as recording paper or a resin film can be used in addition to cloth. Examples of the liquid ejected by the liquid ejecting apparatus 1 include an ink containing a coloring material, a reaction liquid containing an aggregating agent for aggregating the ink, a treatment liquid containing a softening agent, and a post-treatment liquid. The ink in the present embodiment is a liquid having some coloring materials such as dyes and pigments. Examples of the pigment used as the coloring material include inorganic pigments such as carbon used for a black ink, titanium oxide used for a white ink, and alumina used for a silver metallic ink.

By ejecting the reaction liquid to a medium S, and then ejecting the ink to a position at which the reaction liquid lands on the medium S, the reaction liquid and the ink are mixed on the medium S or at a position where the ink permeates into the medium S and the reaction liquid aggregates with the ink. Thus, it is possible to improve the fixability of the ink on the medium S. The reaction liquid may be ejected to a position at which the ink lands on the medium S, during a predetermined period after the ink is ejected to the medium S. The predetermined period is, for example, a period of one pass, which will be described later.

The reaction liquid is a liquid containing the aggregating agent for aggregating the ink. An organic acid may be contained as an aggregating agent for aggregating a coloring material. As the reaction liquid containing the organic acid, a reaction liquid containing at least a glutaric acid, a solvent, and an activator can be adopted, and a reaction liquid containing an organic acid such as citric acid, malic acid, and malonic acid can be used.

Examples of a specific combination of the reaction liquid and the ink include two combinations as follows. The first combination is a reaction liquid having a basic polymer as the aggregating agent and an ink containing an anionic dye. The second combination is a reaction liquid containing an organic compound having two or more cationic groups per molecule as the aggregating agent, and an ink containing an anionic dye. The combination of the reaction liquid and the ink is not limited to the above two combinations.

The post-treatment liquid is an overcoat liquid that covers the ink containing a coloring material, which was landed on the medium S. The post-treatment liquid is a liquid that does not have the coloring material, and improves the fixability of the ink ejected onto the medium S. The post-treatment liquid is also aggregated by the reaction liquid.

The treatment liquid is a liquid containing a softening agent that imparts flexibility to the medium S. The treatment liquid is, for example, silicone oil containing dimethyl silicone, amino-modified silicone (weak anionic), and ether silicone as main components. As another example, the treatment liquid may be a liquid containing either a cationic surfactant or polyester (nonionic) as the main component. By applying the softening agent, it is possible to improve the flexibility, water resistance, and color developing properties of the medium S. The flexibility by the softening agent means a flexible effect obtained by adhering the softening agent to fiber to impart slidability and reduce the friction between threads of fibers. The water resistance by the softening agent means water repellency (water resistance) obtained by the properties of the softening agent, because the softening agent has low surface tension and has properties close to oil. The color developing property by the softening agent means a glossing (darkening) effect obtained by lowering the refractive index by coating the medium S. The treatment liquid is less likely to aggregate with the reaction liquid than the ink containing the coloring material. For example, the ink or the post-treatment liquid reacts instantaneously with the reaction liquid, but the treatment liquid does not instantaneously react with the reaction liquid. For example, the reaction time until the reaction between the ink and the reaction liquid is completed is only about several seconds. Thus, the phrase “less likely to aggregate” means that it takes ten seconds or longer to complete the reaction. In addition, the phrase “less likely to aggregate” includes a time during which the reaction is not completed during one wiping operation, when a wiping member 9 to be described in detail later wipes each ejection surface 120 of the head unit U. Further, the phrase “less likely to aggregate” may include a case where the time from the contact between the treatment liquid and the reaction liquid to the completion of the reaction is equal to or longer than 24 hours.

Such a liquid ejecting apparatus 1 includes the head unit U, a liquid storage section 3, a control unit 4 that is a controller, a transport mechanism 5 that feeds out a medium S, and a moving mechanism 6.

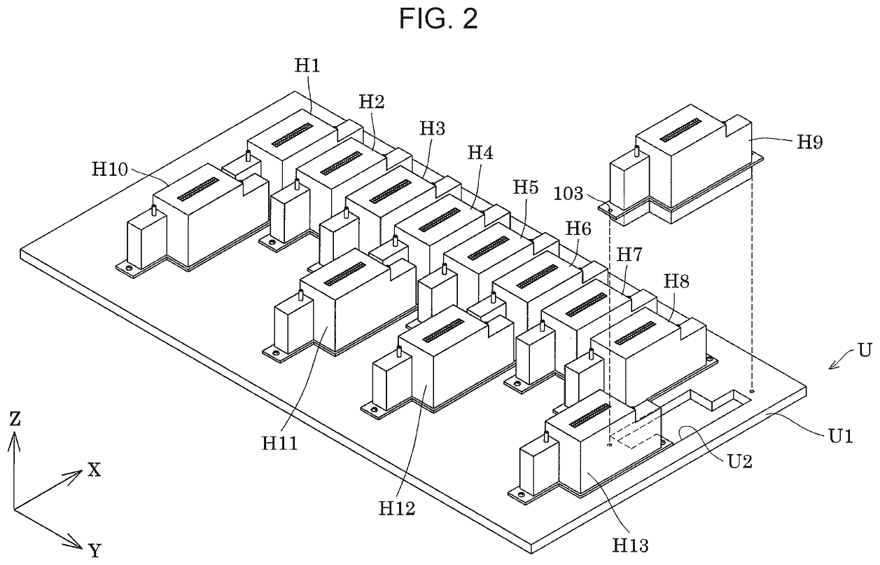

As illustrated in FIG. 2, the head unit U includes a plurality of liquid ejecting heads H and a support U1 that supports the plurality of liquid ejecting heads H. In the present embodiment, 13 liquid ejecting heads H are supported by one common support U1. The plurality of liquid ejecting heads H may be supported by the support U1 divided into two pieces or more, but the head unit U is defined by the support U1, and thus the number of the support U1 corresponds to the number of head units U.

The liquid ejecting head H ejects a liquid supplied from the liquid storage section 3 that stores the liquid as droplets in the +Z direction.

The liquid storage section 3 individually stores a plurality of types of liquids that have different colors or different components and are ejected from the liquid ejecting head H. Examples of the liquid storage section 3 include a cartridge that can be attached to and detached from the liquid ejecting apparatus 1, a bag-shaped ink pack formed of a flexible film, an ink tank that can be refilled with ink, and the like. FIG. 1 illustrates one liquid storage section 3. The liquid storage section 3 may be a liquid storage section 3 having divided rooms for individually storing a plurality of types of liquids, and may be a plurality of liquid storage sections 3 individually provided according to a plurality of types of liquids. Further, the liquid storage section 3 may be divided into a main tank and a sub tank. The sub tank may be coupled to the liquid ejecting head H, and the sub tank is refilled with the liquid consumed by ejecting the droplets from the liquid ejecting head H from the main tank.

The control unit 4 includes a control device such as a central processing unit (CPU) or a field programmable gate array (FPGA), and a storage device such as a semiconductor memory. The control unit 4 is electrically coupled to the liquid ejecting head H via an external wiring (not illustrated). The control unit 4 totally controls each element of the liquid ejecting apparatus 1, that is, the liquid ejecting head H, the transport mechanism 5, the moving mechanism 6, and the like by executing the program stored in the storage device by the control device.

The transport mechanism 5 transports the medium S in the X-axis direction, and has a transport roller 5a. That is, the transport mechanism 5 transports the medium S in the X-axis direction by rotating the transport roller 5a. The transport roller 5a is rotated by driving a transport motor (not illustrated). The control unit 4 controls the transport of the medium S by controlling the drive of the medium transport motor. The transport mechanism 5 that transports the medium S is not limited to the one including the transport roller 5a, and may transport the medium S by a belt or a drum.

The moving mechanism 6 is a mechanism for reciprocating the head unit U in the Y-axis direction, and includes a holding member 7 and a transport belt 8. The holding member 7 is a so-called carriage that holds the head unit U, and is fixed to the transport belt 8. The transport belt 8 is an endless belt erected along the Y-axis direction. The transport belt 8 is rotated by driving a transport motor (not illustrated). The control unit 4 rotates the transport belt 8 by controlling the drive of the transport motor to reciprocate the head unit U together with the holding member 7 in the Y-axis direction. The holding member 7 may be configured to mount the liquid storage section 3 together with the liquid ejecting head H.

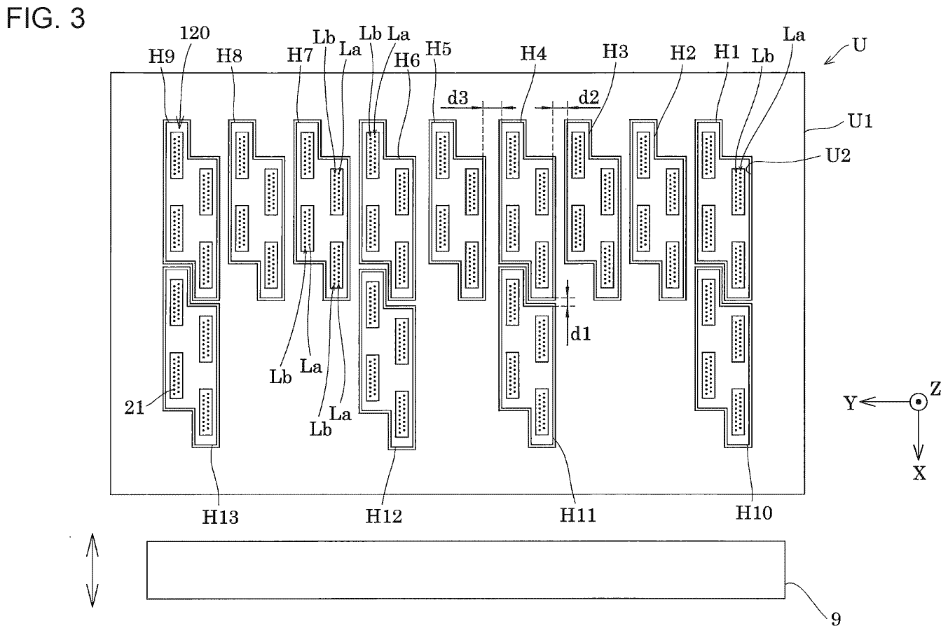

Under the control of the control unit 4, the plurality of liquid ejecting heads H mounted on the head unit U performs an ejection operation of ejecting the liquid supplied from the liquid storage section 3 in the +Z direction as droplets from each of a plurality of nozzles 21 (see FIG. 3). The ejection operation by the liquid ejecting head H is performed in parallel with the transporting of the medium S by the transport mechanism 5 and the reciprocating movement of the liquid ejecting head H by the moving mechanism 6, so that so-called printing in which the liquid is applied to the medium S is performed.

A printing process has two modes, bidirectional printing and unidirectional printing. Moving the head unit U once in the Y-axis direction is referred to as one pass. The period of one pass is a period required to move the head unit U once in the Y-axis direction. In the bidirectional printing, the liquid ejecting apparatus 1 executes a +Y direction printing process of ejecting the liquid while moving the head unit U in the +Y direction to form a partial image corresponding to a band width corresponding to a first pass on the medium S. Then, the liquid ejecting apparatus 1 executes a moving process of moving the medium S in the X-axis direction by the band width and executes a −Y direction printing process of ejecting the liquid while moving the head unit U in the −Y direction to form a partial image corresponding to a band width corresponding to a second pass on the medium S. Thereafter, the liquid ejecting apparatus 1 repeats the +Y direction printing process and the −Y direction printing process until an image is formed at the medium S. In the bidirectional printing, the moving process may be executed after the +Y direction printing process and the −Y direction printing process are executed. The moving process may be executed after each of the +Y direction printing process and the −Y direction printing process is executed a plurality of times. The bidirectional printing can shorten the time required for forming an image on the medium S as compared with unidirectional printing.

In unidirectional printing, the +Y direction printing process described above is executed. Then, the liquid ejecting apparatus 1 executes the moving process of moving the medium S in the X-axis direction by the band width. Thereafter, the liquid ejecting apparatus 1 repeats the +Y direction printing process and the moving process until an image is formed at the medium S. In the unidirectional printing, the moving process may be executed after the +Y direction printing process is executed a plurality of times. At this time, the head unit U does not execute the printing process when moving in the −Y direction. The unidirectional printing may be performed by executing the −Y direction printing process instead of the +Y direction printing process. That is, in the unidirectional printing, the −Y direction printing process and the moving process may be repeated.

The liquid ejecting apparatus 1 includes the wiping member 9 that wipes an ejection surface 120 (see FIG. 3) of the liquid ejecting head H. For example, the wiping member 9 is preferably a material capable of absorbing a liquid, such as a porous material such as a woven fabric, a non-woven fabric, or a sponge. The wiping member 9 may be a plate-shaped blade formed of an elastic material such as rubber. The wiping member 9 wipes the ejection surface 120 in the X-axis direction by moving in the X-axis direction relative to the ejection surface 120 while being in contact with the ejection surface 120 of the liquid ejecting head H. The relative movement in the X-axis direction between the liquid ejecting head H and the wiping member 9 may be performed by moving the liquid ejecting head H, may be performed by moving the wiping member 9, or may be performed by moving both of the liquid ejecting head H and the wiping member 9. In the present embodiment, the wiping member 9 wipes each ejection surface 120 of the liquid ejecting head H by relatively moving in the −X direction with respect to the head unit U.

As illustrated in FIG. 3, the wiping member 9 may be independently provided for each liquid ejecting head H arranged in the Y-axis direction, or may be continuously provided over a head group including a plurality of liquid ejecting heads H arranged in the Y-axis direction. In the present embodiment, the wiping member 9 has a size which is continuous over the maximum number of liquid ejecting heads H arranged in the Y-axis direction, that is, over nine liquid ejecting heads H (to be described in detail later). Therefore, the ejection surfaces 120 of the nine liquid ejecting heads H arranged in the Y-axis direction can be wiped in a manner that the wiping member 9 relatively moves in the −X direction with respect to the head unit U.

The wiping member 9 may have a structure of normally wiping the ejection surface 120 with a surface of a new wiping member 9 by wiping the ejection surface 120 using a woven fabric or a non-woven fabric wound around a roller, and then winding a used portion of the wiping member 9.

In the present embodiment, the X-axis is an example of a “first axis”, and the X-axis direction is an example of a “direction along the first axis” or a “transport direction”. The Y-axis is an example of a “second axis”, and the Y-axis direction is an example of a “direction along the second axis”.

FIG. 2 is an exploded perspective view of the head unit U according to the first embodiment of the present disclosure. FIG. 3 is a schematic view of the head unit U when viewed in the −Z direction. Each direction of the head unit U will be described based on the directions when mounted on the liquid ejecting apparatus 1, that is, the X-axis direction, the Y-axis direction, and the Z-axis direction.

As illustrated, the head unit U includes a plurality of liquid ejecting heads H and a support U1 that commonly supports the plurality of liquid ejecting heads H.

The support U1 is formed of a plate-shaped member formed of a metal material or a resin material, and is provided with a plurality of attachment holes U2 for supporting the liquid ejecting head H. The plurality of liquid ejecting heads H are supported by the support U1 in a state of being inserted into the attachment holes U2.

A plurality of liquid ejecting heads H are supported by such a support U1. In the present embodiment, 13 liquid ejecting heads H are supported by the support U1. The disposition of the liquid ejecting heads H supported by the support U1 will be described later in detail.

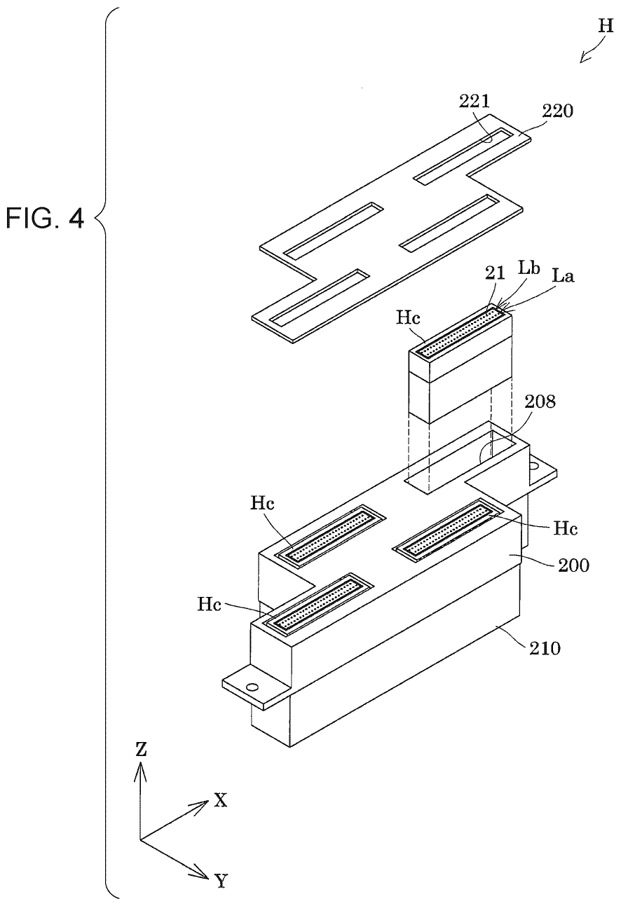

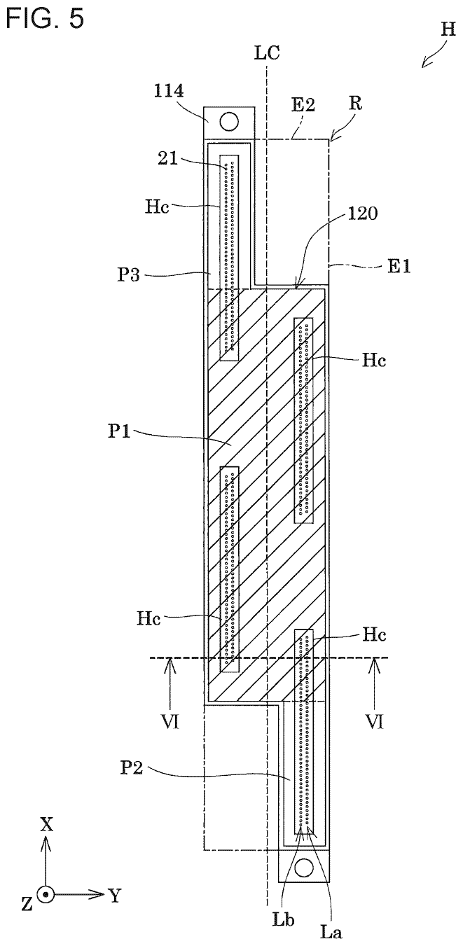

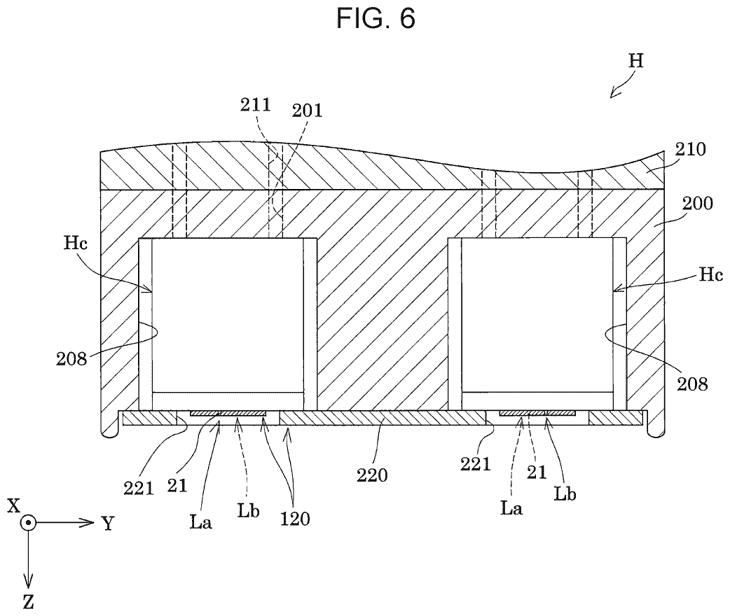

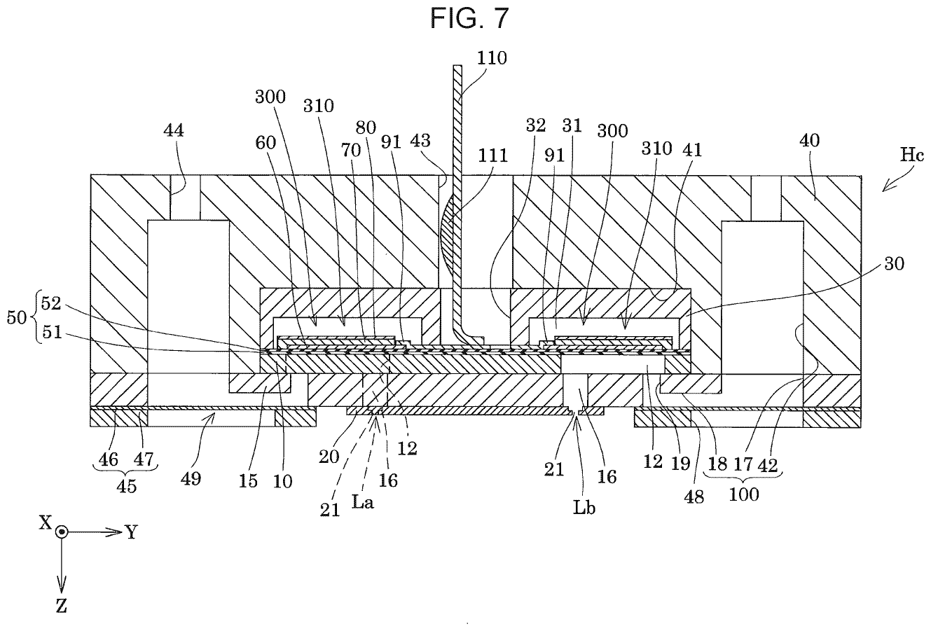

FIG. 4 is an exploded perspective view of the liquid ejecting head H according to the first embodiment of the present disclosure when viewed in the −Z direction. FIG. 5 is a plan view of the liquid ejecting head H when viewed in the −Z direction. FIG. 6 is a cross-sectional view taken along line VI-VI in FIG. 5. FIG. 7 is a cross-sectional view of a head chip Hc along the Y-axis direction. Each direction of the liquid ejecting head H and the head chip Hc will be described based on the directions when mounted on the liquid ejecting apparatus 1, that is, the X-axis direction, the Y-axis direction, and the Z-axis direction.

As illustrated, the liquid ejecting head H includes a plurality of head chips Hc, a holder 200, a flow path member 210, and a cover head 220.

The plurality of head chips Hc and the cover head 220 are fixed to the surface of the holder 200 facing the +Z direction, and the flow path member 210 is fixed to the surface of the holder 200 facing the −Z direction.

As illustrated in FIG. 7, the head chip Hc includes one nozzle plate 20 in which a plurality of nozzles 21 are formed, the flow path forming substrate 10, a communication plate 15, a protective substrate 30, a case member 40, a piezoelectric actuator 300, and the wiring member 110.

The flow path forming substrate 10 is made of, for example, a silicon substrate, a glass substrate, an SOI substrate, or various ceramic substrates. On the flow path forming substrate 10, a plurality of pressure chambers 12 are disposed side by side along the X-axis direction. The plurality of pressure chambers 12 are disposed on a straight line along the X-axis direction such that positions in the Y-axis direction are the same. The two pressure chambers 12 adjacent to each other in the X-axis direction are partitioned by partition walls which are not illustrated. In addition, in the present embodiment, two rows of pressure chambers 12 in which the pressure chambers 12 are arranged side by side in the X-axis direction are provided in the Y-axis direction. The two rows of pressure chambers are disposed to be shifted from each other by a so-called half pitch, that is, by half the pitch between the pressure chambers 12 in the X-axis direction. That is, all the pressure chambers 12 in the two rows of pressure chambers are disposed along the X-axis direction in a staggered manner.

The communication plate 15 and the nozzle plate 20 are sequentially stacked on the surface of the flow path forming substrate 10 facing the +Z direction. A diaphragm 50 and the piezoelectric actuator 300 are sequentially stacked on the surface of the flow path forming substrate 10 facing the −Z direction.

The communication plate 15 is formed of a plate-shaped member bonded to the surface of the flow path forming substrate 10 facing the +Z direction. The communication plate 15 is provided with a nozzle communication passage 16 through which the pressure chamber 12 and the nozzle 21 communicate with each other. The communication plate 15 is provided with a first manifold portion 17 and a second manifold portion 18 that form a portion of a manifold 100 serving as a common liquid chamber with which the plurality of pressure chambers 12 commonly communicate. The first manifold portion 17 is provided to penetrate the communication plate 15 in the Z-axis direction. The second manifold portion 18 is provided to open on the surface on the side facing the +Z direction without penetrating the communication plate 15 in the Z-axis direction. Furthermore, the communication plate 15 is provided with a supply communication passage 19 communicating with the pressure chamber 12 independently in each of the pressure chambers 12. The supply communication passage 19 communicates between the second manifold portion 18 and the pressure chambers 12 to supply the ink in the manifold 100 to the pressure chambers 12. As such a communication plate 15, a silicon substrate, a glass substrate, an SOI substrate, various ceramic substrates, a metal substrate such as a stainless steel substrate, or the like can be used.

The nozzle plate 20 is bonded to the side of the communication plate 15 opposite to the flow path forming substrate 10, that is, to the surface facing the +Z direction. A plurality of nozzles 21 communicating with the respective pressure chambers 12 via nozzle communication passages 16 are formed in the nozzle plate 20. In the present embodiment, the plurality of nozzles 21 are disposed to be arranged in a row along the X-axis direction. In the present embodiment, two nozzle rows L, in which the nozzles 21 are arranged side by side along the X-axis direction, are provided at a distance in the Y-axis direction. In the present embodiment, the two nozzle rows L are referred to as a nozzle row La and a nozzle row Lb in the +Y direction in this order. When the nozzle rows La and Lb are not distinguished from each other, the nozzle rows La and Lb are referred to as the nozzle row L below. The nozzle rows La and Lb are disposed to be shifted from each other by a so-called half pitch, that is, by half the pitch between the nozzles 21, in the X-axis direction. That is, all of the nozzles 21 in the nozzle rows La and Lb are disposed in a staggered manner along the X-axis direction. In the present embodiment, as illustrated in FIG. 5, the nozzle row La is located in the −X direction from the nozzle row Lb. That is, the nozzle 21 at the end portion of the nozzle row La in the −X direction is located in the −X direction from the nozzle 21 at the end portion of the nozzle row Lb in the −X direction.

As such a nozzle plate 20, a silicon substrate, a glass substrate, an SOI substrate, various ceramic substrates, a metal substrate such as a stainless steel substrate, an organic substance such as a polyimide resin, or the like can be used. A surface of the nozzle plate 20 facing the +Z direction forms a portion of the ejection surface 120 of the liquid ejecting head H.

In the present embodiment, the diaphragm 50 includes an elastic film 51 that is provided on the flow path forming substrate 10 side and is formed of silicon oxide, and an insulator film 52 that is provided on the surface of the elastic film 51 facing the −Z direction and is formed of zirconium oxide. The diaphragm 50 may be formed of only the elastic film 51 or only the insulator film 52, and may have a configuration in which other films are provided in addition to the elastic film 51 and the insulator film 52.

The piezoelectric actuator 300 includes a first electrode 60, a piezoelectric layer 70, and a second electrode 80 that are sequentially stacked on the diaphragm 50 in the −Z direction. Such a piezoelectric actuator 300 is also referred to as a piezoelectric element, and refers to a portion including the first electrode 60, the piezoelectric layer 70, and the second electrode 80. In addition, a portion where piezoelectric strain occurs in the piezoelectric layer 70 when a voltage is applied between the first electrode 60 and the second electrode 80 is referred to as an active portion 310. That is, the active portion 310 refers to a portion where the piezoelectric layer 70 is interposed between the first electrode 60 and the second electrode 80. In the present embodiment, the active portion 310 is formed for each pressure chamber 12. The plurality of active portions 310 serve as “driving elements” that cause pressure changes in the ink inside the pressure chamber 12. In general, any one of the electrodes of the active portion 310 is configured as an independent individual electrode for each active portion 310, and the other electrode is configured as a common electrode common to the plurality of active portions 310. In the present embodiment, the first electrode 60 is separated for each active portion 310 to form an individual electrode of the active portion 310, and the second electrode 80 is continuously provided over the plurality of active portions 310 to form a common electrode for the plurality of active portions 310. The first electrode 60 may form a common electrode, and the second electrode 80 may form an individual electrode.

The piezoelectric layer 70 is configured by using a piezoelectric material made of, for example, a perovskite structure composite oxide represented by the general formula ABO₃.

An individual lead electrode 91, which is a lead-out wiring, is drawn out from the first electrode 60. A common lead electrode, which is a lead-out wiring (not illustrated), is drawn out from the second electrode 80. The wiring member 110 formed of a flexible substrate having flexibility is coupled to the end portions of the individual lead electrode 91 and the common lead electrode opposite to the end portions thereof coupled to the piezoelectric actuator 300. A drive signal selection circuit 111 is mounted on the wiring member 110. The drive signal selection circuit 111 has a plurality of switching elements for selecting whether or not to supply a drive signal COM for driving each active portion 310 to each active portion 310. That is, the wiring member 110 in the present embodiment is a chip-on-film (COF). The drive signal selection circuit 111 may not be provided in the wiring member 110. That is, the wiring member 110 may be a flexible flat cable (FFC), a flexible printed circuits (FPC), and the like.

The protective substrate 30 having approximately the same size as the flow path forming substrate 10 is bonded to the surface of the flow path forming substrate 10 facing the −Z direction. The protective substrate 30 includes an accommodation portion 31 which is a space for protecting the piezoelectric actuator 300. The accommodation portion 31 is independently provided for each row of the piezoelectric actuators 300 disposed to be arranged in the X-axis direction. Two accommodation portions 31 are formed to be arranged in the Y-axis direction. A through-hole 32 penetrating in the Z-axis direction is provided between the two accommodation portions 31 disposed to be arranged in the Y-axis direction, in the protective substrate 30. The end portions of the individual lead electrode 91 and the common lead electrode 92 drawn out from the electrodes of the piezoelectric actuator 300 are extended to be exposed in the through-hole 32. The individual lead electrode 91 and the common lead electrode 92 are electrically coupled to the wiring member 110 in the through-hole 32. As such a protective substrate 30, for example, a substrate made of a silicon substrate, a glass substrate, an SOI substrate, and various ceramic substrates is used similarly to the flow path forming substrate 10.

A case member 40 for defining the manifold 100 communicating with the plurality of pressure chambers 12 together with the flow path forming substrate 10 is fixed on the protective substrate 30. The case member 40 has substantially the same shape as the communication plate 15 described above in plan view, and is bonded to the protective substrate 30 and also bonded to the communication plate 15 described above. Such a case member 40 has a recess portion 41 having a depth for accommodating the flow path forming substrate 10 and the protective substrate 30 on the protective substrate 30 side. The case member 40 is provided with a third manifold portion 42 communicating with the first manifold portion 17 of the communication plate 15. The first manifold portion 17 and the second manifold portion 18 provided in the communication plate 15 and the third manifold portion 42 provided in the case member 40 configure the manifold 100 of the present embodiment. The manifold 100 is provided for each of the nozzle rows La and Lb, that is, two manifolds in total are provided. Therefore, different liquids can be ejected from the nozzle rows La and Lb. The case member 40 is provided with an inlet 44 that communicates with the manifolds 100 to supply an ink to each of the manifolds 100. In addition, the case member 40 is provided with a coupling port 43 through which the wiring member 110 is inserted to communicate with the through-hole 32 of the protective substrate 30. The wiring member 110 is flowed out to the surface side of the liquid ejecting head H facing the −Z direction, via the coupling port 43. As the case member 40, a metal material, a resin material, or the like can be used.

A compliance substrate 45 is provided on the surface of the communication plate 15 on the +Z direction side where the first manifold portion 17 and the second manifold portion 18 are open. The compliance substrate 45 seals the openings of the first manifold portion 17 and the second manifold portion 18 on the +Z direction side. Such a compliance substrate 45 includes a sealing film 46 made of a flexible thin film and a fixation substrate 47 made of a hard material such as metal in the present embodiment. Since a region of the fixation substrate 47 facing the manifold 100 is an opening 48 that is completely removed in the thickness direction, one surface of the manifold 100 is a compliance portion 49 which is a flexible portion sealed only by the flexible sealing film 46. The head chip Hc is fixed to the cover head 220 by fixing the surface of the fixation substrate 47 facing the +Z direction to the surface of the cover head 220 facing the −Z direction.

In such a head chip Hc, the liquid is taken in from the inlet 44, and the inside of the flow path from the manifold 100 to the nozzle 21 is filled with the liquid. Thereafter, a voltage is applied to each active portion 310 corresponding to the pressure chamber 12 in accordance with a signal from the drive signal selection circuit 111, and thus the diaphragm 50 is flexurally deformed along with the piezoelectric actuator 300. Thus, pressure of the liquid in the pressure chamber 12 increases, and droplets are ejected from a predetermined nozzle 21.

The holder 200 is made of a metal material, a resin material, or the like. An accommodation portion 208 that accommodates the head chip Hc is provided on the surface of the holder 200 facing the +Z direction. The accommodation portion 208 has a recessed shape that opens in the +Z direction of the holder 200, and is provided independently for each head chip Hc. In the present embodiment, the holder 200 is provided with four accommodation portions 208, and four head chips Hc are accommodated. The accommodation portion 208 may be continuously provided over a group constituted by a plurality of head chips Hc.

Here, four head chips Hc are provided in the X-axis direction with respect to the holder 200. The four head chips Hc are arranged in a staggered manner along the X-axis direction. Here, the phrase that the plurality of head chips Hc are disposed in a staggered manner along the X-axis direction means that the head chips Hc arranged side by side in the X-axis direction are alternately disposed to shift from each other in the Y-axis direction. In other words, two rows of the head chips Hc arranged along the X-axis are arranged side by side along the Y-axis, and two rows of head chips Hc are disposed to shift from each other in the X-axis direction by a half pitch. By disposing the plurality of head chips Hc in a staggered manner along the X-axis direction in this manner, the nozzle rows L of the two head chips Hc can be partially overlapped in the X-axis direction to form a row of nozzles 21 that is continuous in the X-axis direction.

The holder 200 is provided with a first flow path 201 communicating with the inlet 44 of the head chip Hc accommodated in the accommodation portion 208.

The cover head 220 is fixed to the surface of the holder 200 facing the +Z direction. The cover head 220 defines a space of the accommodation portion 208 that accommodates the head chip Hc. Further, the cover head 220 is bonded to the compliance substrate 45 of the head chip Hc accommodated in the accommodation portion 208. In the present embodiment, the cover head 220 has a size enough for covering four head chips Hc. In addition, the cover head 220 is provided with an exposure opening portion 221 that exposes a nozzle 21 of the head chip Hc in the +Z direction independently for each head chip Hc. A liquid is ejected from the nozzle 21 exposed from the exposure opening portion 221 in the +Z direction. The surface of the cover head 220 facing the +Z direction forms a portion of the ejection surface 120 of the liquid ejecting head H. That is, the ejection surface 120 of the liquid ejecting head H includes the surface of the nozzle plate 20 exposed by the exposure opening portion 221 of the nozzle plate 20 and the surface of the cover head 220 facing the +Z direction.

The flow path member 210 is fixed to the surface of the holder 200 facing the −Z direction. A second flow path 211 communicating with the first flow path 201 of the holder 200 is provided inside the flow path member 210. The liquid supplied from the liquid storage section 3 is supplied to each head chip Hc through the second flow path 211 and the first flow path 201. In the second flow path 211 of the flow path member 210, a filter that captures foreign matter such as dust and air bubbles contained in the liquid, a pressure adjusting valve that adjusts the pressure of the liquid supplied to the downstream by opening and closing according to the pressure of the flow path on the downstream, and the like may be provided. The flow path member 210 may be provided with a circulation flow path for collecting the liquid in the flow path, which is not ejected from the nozzle 21 of the head chip Hc.

As illustrated in FIG. 5, the ejection surface 120 of the liquid ejecting head H includes a first portion P1 (a portion indicated by hatching), a second portion P2, and a third portion P3 when viewed in the −Z direction. When the ejection surface 120 of the liquid ejecting head H is viewed in a plan view in the +Z direction and a rectangle having the minimum area including the ejection surface 120 of the liquid ejecting head H is set as R, a long side E1 of the rectangle R is parallel to a side of the outer periphery of the liquid ejecting head H along the X-axis, and a short side E2 of the rectangle R is parallel to a side of the outer periphery of the liquid ejecting head H along the Y-axis. The center line parallel to the long side E1 of the virtual rectangle R is set to LC.

The first portion P1 is a rectangular portion through which the center line LC passes. The second portion P2 is a rectangular portion protruding from the first portion P1 in the +X direction. The third portion P3 is a rectangular portion protruding from the first portion P1 in the −X direction. That is, the second portion P2, the first portion P1, and the third portion P3 are arranged in the −X direction in this order.

The second portion P2 and the third portion P3 are located in opposite directions along the Y-axis with the center line LC interposed therebetween. Then, for example, when two liquid ejecting heads H are arranged in the X-axis direction, the plurality of liquid ejecting heads H are arranged in the X-axis direction such that the second portion P2 of one liquid ejecting head H and the third portion P3 of the other liquid ejecting head H among the two liquid ejecting heads H face each other in the Y-axis direction. In this manner, by disposing the second portion P2 of one liquid ejecting head H and the third portion P3 of the other liquid ejecting head H to face each other in the Y-axis direction, the nozzles 21 of the liquid ejecting heads H that are adjacent to each other along the X-axis direction can be partially overlapped in the X-axis direction to form a row of nozzles 21 that is continuous in the X-axis direction. The second portion P2 and the third portion P3 have a width in the Y-axis direction that does not pass through the center line LC. Therefore, when the plurality of liquid ejecting heads H are arranged in the X-axis direction, it is possible to further narrow the width occupied by the plurality of liquid ejecting heads H in the Y-axis direction. When one liquid ejecting head H is used without arranging two or more liquid ejecting heads H in the X-axis direction, the liquid ejecting head H may be set to have a rectangular shape when viewed in the −Z direction, but it is necessary that the liquid ejecting heads H are required to be manufactured as one liquid ejecting head H arranged in the X-axis direction and two liquid ejecting heads H arranged in the X-axis direction. Therefore, by using the liquid ejecting head H in the present embodiment, which is not limited in the number of liquid ejecting heads to be used, it is not necessary to dedicatedly manufacture the liquid ejecting head H, and it is possible to share the components, and to reduce the cost.

One nozzle row La of each of the four head chips Hc in such one liquid ejecting head H ejects the same type of liquid, and the other nozzle row Lb of each of the four head chips Hc in one liquid ejecting head H ejects the same type of liquid. The same type of liquid may be ejected from the nozzle row La and the nozzle row Lb of each of the four head chips Hc in one liquid ejecting head H.

A plurality of such liquid ejecting heads H are supported by the support U1. Here, as illustrated in FIG. 3, a first row of the nine liquid ejecting heads H disposed to be arranged along the Y-axis and a second row of the four liquid ejecting heads H disposed to be arranged along the Y-axis are disposed in the support U1 to be arranged in the X-axis direction. In the present embodiment, the nine liquid ejecting heads H constituting the first row are referred to as liquid ejecting heads H1 to H9 in the +Y direction in order, and the four liquid ejecting heads H constituting the second row are referred to as liquid ejecting heads H10 to H13 in the +Y direction in order. When the liquid ejecting heads H1 to H13 are not distinguished from each other, the liquid ejecting heads H1 to H13 are referred to as the liquid ejecting head H below.

Here, the phrase that two liquid ejecting heads H are disposed to be arranged along the Y-axis means that the two liquid ejecting heads H are disposed to be located at the same position in the X-axis direction and at different positions in the Y-axis direction. The phrase that two liquid ejecting heads H are disposed at the same position in the X-axis direction means that the ejection surface 120 of one liquid ejecting head H and the ejection surface 120 of the other liquid ejecting head H are disposed at the same position in the X-axis direction. This phrase includes a case where each nozzle 21 constituting the nozzle row L of one liquid ejecting head H and each nozzle 21 constituting the nozzle row L of the other liquid ejecting head H are not disposed at the same position in the X-axis direction as long as the ejection surfaces 120 of two liquid ejecting heads H are disposed at the same position in the X-axis direction. Further, the phrase that the two liquid ejecting heads H are disposed at different positions in the Y-axis direction means that the centers of the ejection surfaces 120 of the two liquid ejecting heads H in the Y-axis direction are disposed at different positions in the Y-axis direction. That is, the phrase that the two liquid ejecting heads H are disposed at different positions in the Y-axis direction includes a case where the ejection surface 120 of the two liquid ejecting heads H partially overlap each other when viewed in the X-axis direction.

The first row constituted by the liquid ejecting heads H1 to H9 and the second row constituted by the liquid ejecting heads H10 to H13, as described above, are disposed to be arranged along the X-axis. In the present embodiment, the second row is located in the +X direction with respect to the first row.

Among the liquid ejecting heads H1 to H9, two liquid ejecting heads H(n) and H(n+1) (n is an integer of 1 to 8) are disposed to be adjacent to each other in the Y-axis direction. Here, the phrase that the two liquid ejecting heads H(n) and H(n+1) are adjacent to each other means that the two liquid ejecting heads H(n) and H(n+1) are disposed at a distance, and another liquid ejecting head H is not provided between the two liquid ejecting heads H(n) and H(n+1). Similarly, among the liquid ejecting heads H10 to H12, two liquid ejecting heads H(n) and H(n+1) (n is 10 or 11) are disposed to be adjacent to each other in the Y-axis direction.

The liquid ejecting head H1 and the liquid ejecting head H10 are disposed to be arranged along the X-axis. The liquid ejecting head H4 and the liquid ejecting head H11 are disposed to be arranged along the X-axis. The liquid ejecting head H6 and the liquid ejecting head H12 are disposed to be arranged along the X-axis. The liquid ejecting head H9 and the liquid ejecting head H13 are disposed to be arranged along the X-axis.

Here, the phrase that two liquid ejecting heads H are disposed to be arranged along the X-axis means that the two liquid ejecting heads H are disposed to be located at the same position in the Y-axis direction and at different positions in the X-axis direction. The phrase that two liquid ejecting heads H are disposed at the same position in the Y-axis direction means that the ejection surface 120 of one liquid ejecting head H and the ejection surface 120 of the other liquid ejecting head H are disposed at the same position in the Y-axis direction. This phrase includes a case where each nozzle 21 constituting the nozzle row L of one liquid ejecting head H and each nozzle 21 constituting the nozzle row L of the other liquid ejecting head H are not disposed at the same position in the Y-axis direction as long as the ejection surfaces 120 of two liquid ejecting heads H are disposed at the same position in the Y-axis direction. Further, the phrase that the two liquid ejecting heads H are disposed at different positions in the X-axis direction means that the centers of the ejection surfaces 120 of the two liquid ejecting heads H in the X-axis direction are disposed at different positions in the X-axis direction. That is, the phrase that the two liquid ejecting heads H are disposed at different positions in the X-axis direction includes a case where the ejection surface 120 of the two liquid ejecting heads H partially overlap each other when viewed in the Y-axis direction.

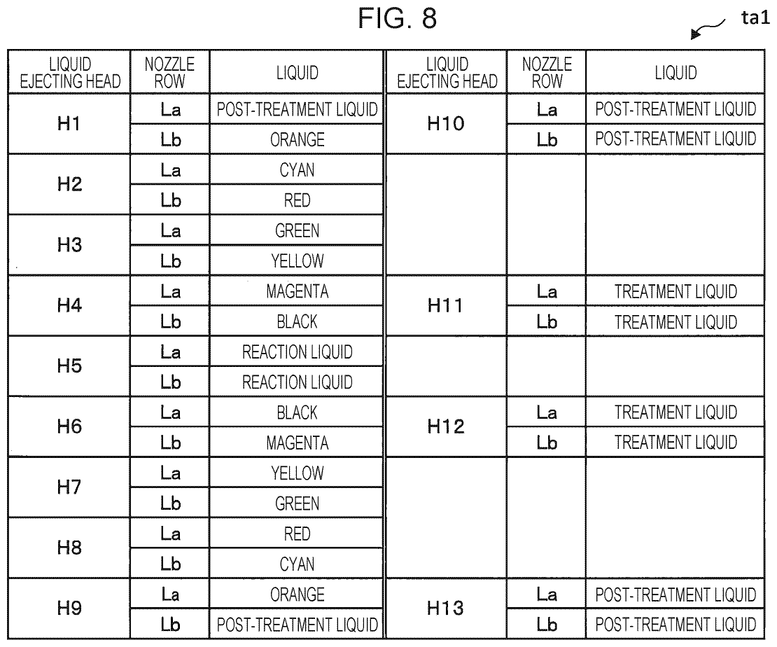

Table ta1 illustrated in FIG. 8 shows a correspondence between the disposition of each liquid ejecting head H and the liquid to be ejected. Since all combinations of the two types of liquids ejected by each of the four head chips Hc in one liquid ejecting head H are same as each other, the description for each head chip Hc is omitted in Table 1.

As shown in Table ta1, in the head unit U, the nozzle rows La and Lb of the liquid ejecting head H5 located at the center in the Y-axis direction eject the reaction liquid.

With respect to the liquid ejecting head H5, the nozzle rows La and Lb of the liquid ejecting heads H4 to H2 located in the −Y direction and the nozzle row Lb of the liquid ejecting head H1 located at the end portion in the −Y direction eject inks containing coloring materials. The nozzle row La of the liquid ejecting head H1 located at the end portion in the −Y direction ejects the post-treatment liquid.

With respect to the liquid ejecting head H5, the nozzle rows La and Lb of the liquid ejecting heads H6 to H8 located in the +Y direction and the nozzle row La of the liquid ejecting head H9 located at the end portion in the +Y direction eject inks containing coloring materials. The nozzle row Lb of the liquid ejecting head H9 located at the end portion in the +Y direction ejects the post-treatment liquid.

As described above, since the nozzle row L of the liquid ejecting head H5 ejects the reaction liquid, and the nozzle rows L of the liquid ejecting heads H4 and H6 eject the inks, it is possible to increase the distance in the Y-axis direction between the nozzle row L for ejecting the reaction liquid and the nozzle row L for ejecting the ink, as compared to a case where the reaction liquid and the ink are ejected from the common ejection surface 120. Therefore, it is possible to suppress an occurrence of ejection failure such as clogging of the nozzle 21 or the shift of the flight direction of the liquid from the nozzle 21, which has caused by the aggregates obtained when the reaction liquid and the ink react with each other and are aggregated on the ejection surface 120.

Here, disposition is made such that the liquid ejected from the nozzle rows La and Lb of the liquid ejecting heads H4 to H1 located in the −Y direction of the liquid ejecting head H5 and the liquid ejected from the nozzle rows La and Lb of the liquid ejecting heads H6 to H9 located in the +Y direction of the liquid ejecting head H5 have the same order in the +Y direction and the −Y direction by using the liquid ejecting head H5 as a reference. That is, the order of the liquids ejected from the nozzle rows La and Lb arranged in the −Y direction from the liquid ejecting head H5 and the order of the liquids ejected from the nozzle rows La and Lb arranged in the +Y direction from the liquid ejecting head H5 are the same.

Specifically, the nozzle row Lb of the liquid ejecting head H4 is disposed at the first position in the −Y direction with respect to the liquid ejecting head H5, and the nozzle row La of the liquid ejecting head H6 is disposed at the first position in the +Y direction with respect to the liquid ejecting head H5. The nozzle row Lb of the liquid ejecting head H4 and the nozzle row La of the liquid ejecting head H6 eject the same type of ink, and a black ink in the present embodiment.

The nozzle row La of the liquid ejecting head H4 is disposed at the second position in the −Y direction with respect to the liquid ejecting head H5, and the nozzle row Lb of the liquid ejecting head H6 is disposed at the second position in the +Y direction with respect to the liquid ejecting head H5. The nozzle row La of the liquid ejecting head H4 and the nozzle row Lb of the liquid ejecting head H6 eject a magenta ink.

The nozzle row La of the liquid ejecting head H3 is disposed at the third position in the −Y direction with respect to the liquid ejecting head H5, and the nozzle row Lb of the liquid ejecting head H7 is disposed at the third position in the +Y direction with respect to the liquid ejecting head H5. The nozzle row Lb of the liquid ejecting head H3 and the nozzle row La of the liquid ejecting head H7 eject a yellow ink.

The nozzle row La of the liquid ejecting head H3 is disposed at the fourth position in the −Y direction with respect to the liquid ejecting head H5, and the nozzle row Lb of the liquid ejecting head H7 is disposed at the fourth position in the +Y direction with respect to the liquid ejecting head H5. The nozzle row La of the liquid ejecting head H3 and the nozzle row Lb of the liquid ejecting head H7 eject a green ink.

The nozzle row Lb of the liquid ejecting head H2 is disposed at the fifth position in the −Y direction with respect to the liquid ejecting head H5, and the nozzle row La of the liquid ejecting head H8 is disposed at the fifth position in the +Y direction with respect to the liquid ejecting head H5. The nozzle row Lb of the liquid ejecting head H2 and the nozzle row La of the liquid ejecting head H8 eject a red ink.

The nozzle row La of the liquid ejecting head H2 is disposed at the sixth position in the −Y direction with respect to the liquid ejecting head H5, and the nozzle row Lb of the liquid ejecting head H8 is disposed at the sixth position in the +Y direction with respect to the liquid ejecting head H5. The nozzle row La of the liquid ejecting head H2 and the nozzle row Lb of the liquid ejecting head H8 eject a cyan ink.

The nozzle row Lb of the liquid ejecting head H1 is disposed at the seventh position in the −Y direction with respect to the liquid ejecting head H5, and the nozzle row La of the liquid ejecting head H9 is disposed at the seventh position in the +Y direction with respect to the liquid ejecting head H5. The nozzle row Lb of the liquid ejecting head H1 and the nozzle row La of the liquid ejecting head H9 eject an orange ink.

The nozzle row La of the liquid ejecting head H1 is disposed at the eighth position in the −Y direction with respect to the liquid ejecting head H5, and the nozzle row Lb of the liquid ejecting head H9 is disposed at the eighth position in the +Y direction with respect to the liquid ejecting head H5. The nozzle row La of the liquid ejecting head H1 and the nozzle row Lb of the liquid ejecting head H9 eject the post-treatment liquid.

With such a configuration, in the plurality of liquid ejecting heads H, the nozzle rows L arranged in the Y-axis direction are disposed in an order in the +Y direction and an order in the −Y direction from the liquid ejecting head H5 in this order of the black ink, the magenta ink, the green ink, the red ink, the cyan ink, the orange ink, and the post-treatment liquid.

The two nozzle rows La and Lb of the liquid ejecting head H5 eject the reaction liquid. Therefore, regardless of the head unit U moving in the +Y direction and in the −Y direction, the ejection order of the reaction liquid, the inks containing the coloring materials, and the post-treatment liquid can be similarly set to have the same order.

The nozzle rows La and Lb arranged in order in the +Y direction with respect to the liquid ejecting head H5 and the nozzle rows La and Lb arranged in order in the −Y direction are disposed at substantially the same distance. “Substantially the same” includes not only the case of being completely the same but also the case of being considered to be the same in consideration of manufacturing errors.

Thus, when the head unit performs printing by reciprocating in the Y-axis direction, the order of moving in the +Y direction and ejecting the liquid and the order of moving in the −Y direction and ejecting the liquid are set to be the same. Thus, it is possible to set the overlapping order of the liquids on the medium S to be the same, and to set a difference of time of landing the liquid between different types of liquids to be the same. Therefore, it is possible to suppress the difference in the color due to the difference in a scanning direction and the difference in the degree of aggregation of the ink due to the difference in the scanning direction, and to improve the printing quality.

In the present embodiment, by ejecting the ink, the reaction liquid, and the post-treatment liquid from the liquid ejecting heads H1 to H9 arranged along the Y-axis, the ink, the reaction liquid, and the post-treatment liquid can be ejected within the same pass. Therefore, since the ink and the post-treatment liquid can be caused to react with the reaction liquid for each pass, it is less likely to cause the medium S to bleed.

Here, the printing process in the first row will be described in detail. When the +Y direction printing process is executed, the reaction liquid is ejected from the liquid ejecting head H5 to the medium S, and then the inks are ejected to the medium S in order of the nozzle rows Lb of the liquid ejecting head H4, the liquid ejecting head H3, and the liquid ejecting head H2, and the liquid ejecting head H1. Thereafter, the post-treatment liquid is ejected to the medium S from the nozzle row La of the liquid ejecting head H1. On the other hand, when the −Y direction printing process is executed, the reaction liquid is ejected from the liquid ejecting head H5 to the medium S, and then the inks are ejected to the medium S in order of the nozzle rows La of the liquid ejecting head H6, the liquid ejecting head H7, the liquid ejecting head H8, and the liquid ejecting head H9. Thereafter, the post-treatment liquid is ejected to the medium S from the nozzle row Lb of the liquid ejecting head H9. When the printing process in the first row is ended, the moving process of moving the medium S in the X-axis direction by the band width is executed, and the printing process in the second row is executed. In the printing process in the second row, the post-treatment liquid is ejected to the medium S from the liquid ejecting heads H10 and H13, and then the treatment liquid is ejected to the medium S from the liquid ejecting heads H12 and H11.

Since the liquid ejecting head H5 that ejects the reaction liquid is disposed at the center in the Y-axis direction, both printing when the head unit U moves in the +Y direction and printing when the head unit U moves in the −Y direction are set to have the same order of ejecting the inks containing the coloring materials and the reaction liquid. Thus, it is possible to suppress an occurrence of a color difference due to the moving direction of the head unit U.

In the disposition of the liquid ejecting heads H1 to H9 in the present embodiment, the nozzle row Lb of the liquid ejecting head H4 and the nozzle row La of the liquid ejecting head H6 that eject the same type of liquid, for example, the black ink, are disposed at positions shifted from each other in the X-axis direction by a half pitch. Therefore, without transporting the medium S, it is possible to perform printing at a resolution twice the pitch between the nozzles 21 of the nozzle row L in two passes. Thus, it is possible to perform high-resolution printing at a high speed. The same applies not only to the black ink but also to other inks, and the same applies to the post-treatment liquid ejected from the liquid ejecting heads H1 and H9.

In the present embodiment, since the ink containing the coloring material is ejected from the liquid ejecting heads H4 and H6 near the liquid ejecting head H5 that ejects the reaction liquid, as compared with a case where the post-treatment liquid is ejected from the liquid ejecting heads H4 and H6, it is possible to shorten the time until the ink containing the coloring material reacts with the reaction liquid on the medium S. In addition, it is possible to suppress the bleeding of the ink and improve the image quality.

The nozzle row La of the liquid ejecting head H1 and the nozzle row Lb of the liquid ejecting head H9 that are located at both end portions in the Y-axis direction eject the post-treatment liquid. Therefore, when the head unit U is moved in the +Y direction, the inks containing the coloring materials can be landed on the medium by the liquid ejecting heads H1 to H4, and then the post-treatment liquid for the inks containing the coloring materials on the medium S can be ejected from the nozzle row La of the liquid ejecting head H1. When the head unit U is moved in the −Y direction, the inks containing the coloring materials can be landed on the medium by the liquid ejecting heads H6 to H9, and then the post-treatment liquid for the inks containing the coloring materials on the medium S can be ejected from the nozzle row Lb of the liquid ejecting head H9. Thus, it is not necessary to wastefully reciprocate the head unit U in the Y-axis direction in order to eject the post-treatment liquid. That is, both when the head unit U is moved in the +Y direction and when the head unit U is moved in the −Y direction, ejection can be performed without changing the order of ejection of the inks containing the coloring materials, the reaction liquid, and the post-treatment liquid. Thus, it is possible to shorten the printing time.

The liquid ejecting head H11 is arranged with the liquid ejecting head H4 along the X-axis, and the liquid ejecting head H12 is arranged with the liquid ejecting head H6 along the X-axis. The nozzle rows La and Lb of the liquid ejecting heads H11 and H12 eject the treatment liquid containing a softening agent.

Here, there is a concern that the reaction liquid ejected from the liquid ejecting head H5 becomes mist and adheres to the ejection surfaces 120 of the liquid ejecting heads H4 and H6 that eject the inks containing the coloring materials in the vicinity. When the reaction liquid adheres to the ejection surfaces 120 of the liquid ejecting heads H4 and H6, the ink and the reaction liquid may react and aggregate with each other, and this aggregate may causes the ejection failure such as clogging of the nozzle 21 and the shift of the flight direction of the liquid. However, since the liquid ejecting heads H11 and H12 that eject the treatment liquid are disposed at the respective positions at which the liquid ejecting heads H4 and H6 are arranged along the X-axis, the wiping member 9 is relatively moved in the −X direction to continuously wipe the ejection surfaces 120 of the liquid ejecting heads H11 and H12 and the ejection surfaces 120 of the liquid ejecting heads H4 and H6 in this order, it is possible to suppress the occurrence of the ejection failures of the nozzles 21 of the liquid ejecting heads H4 and H6. Specifically, the wiping member 9 wipes the ejection surfaces 120 of the liquid ejecting heads H11 and H12, and then wipes the ejection surfaces 120 of the liquid ejecting heads H4 and H6. At this time, the wiping member 9 wipes the ejection surfaces 120 of the liquid ejecting heads H11 and H12, thereby wiping the ejection surfaces 120 of the liquid ejecting heads H4 and H6 in a state where the treatment liquid adheres to the wiping member 9. Since the treatment liquid contains the softening agent as described above, it is possible to reduce friction with the ejection surface 120. Therefore, it is possible to strongly press the wiping member 9 to which the treatment liquid adheres, against the ejection surfaces 120 of the liquid ejecting heads H4 and H6, and to perform wiping with a relatively strong force. As described above, since the wiping member 9 wipes the ejection surfaces 120 of the liquid ejecting heads H4 and H6 with a relatively strong force, it is possible to easily recover the ejection failure of the nozzles 21 of the liquid ejecting heads H4 and H6.

When the wiping member 9 wipes the ejection surface 120, it is preferable to perform the wiping after so-called flushing that is ejection from the nozzle row L of the liquid ejecting head H to a portion other than the medium S, or so-called pressurization cleaning of discharging the liquid from the nozzle 21 by pressurizing the liquid in the manifold 100 is performed. As described above, by performing flushing or pressurization cleaning before wiping with the wiping member 9, it is possible to actively apply the treatment liquid onto at least one of the wiping member 9 and the ejection surface 120. In addition, by performing the wiping operation in a state where a sufficient treatment liquid is adhered to the wiping member 9, it is possible to easily recover the ejection failure of the nozzles 21 of the liquid ejecting heads H4 and H6.

When an inorganic pigment is used as the coloring material, the inorganic pigment has a relatively large average particle diameter and is thus likely to cause scratch to the ejection surface 120 during the wiping operation, but, since friction between the ejection surface 120 and the wiping member 9 can be reduced by the treatment liquid, a scratch is less likely to occur on the ejection surface 120 due to the pigment. That is, according to the present embodiment, by mixing the ink and the treatment liquid on the ejection surface 120, it is possible to reduce the friction between the ejection surface 120 and the wiping member 9 and to suppress an occurrence of a scratch on the ejection surface 120. Thus, the ink containing the inorganic pigment having a relatively large average particle diameter can be ejected from the liquid ejecting heads H4 and H6. The black ink has a large use amount and a large ejection amount as compared with inks of other colors. Thus, by ejecting the black ink from the liquid ejecting heads H4 and H6 near the liquid ejecting head H5 that ejects the reaction liquid, in the Y-axis direction, it is possible to shorten the time for the black ink to react with the reaction liquid on the medium S and to suppress the bleeding of the black ink on the medium S.

The reaction-liquid mist is less likely to adhere to the ejection surfaces 120 of the liquid ejecting heads H7 to H9 and H3 to H1 that are far from the liquid ejecting head H5 that ejects the reaction liquid in the Y-axis direction, and the ink on the ejection surface 120 is less likely to aggregate by the reaction liquid. Thus, the ejection failure of the nozzle 21 is less likely to occur. Therefore, in the liquid ejecting heads H7 to H9 and the liquid ejecting heads H3 to H1, the ejection failure of the nozzle 21 due to the adhesion of the reaction-liquid mist is unlikely to occur.

In order to prevent un-reaction between the ink and the reaction liquid, in general, the ejection amount of the reaction liquid from the liquid ejecting head H5 is larger than the ejection amount of the ink from the liquid ejecting heads H4 and H6. When the nozzle rows L are disposed such that the colors of the inks ejected bilaterally symmetrically with the liquid ejecting head H5 as the center in the Y-axis direction are arranged, in order to keep the order of ejection, the liquid ejecting heads H6 to H9 disposed in the +Y direction with respect to the liquid ejecting head H5 are used only in one of a forward path and a backward path, and the liquid ejecting heads H4 to H1 disposed in the −Y direction are used only in the other of the forward path and the backward path. On the other hand, since the liquid ejecting head H5 that ejects the reaction liquid is used on both the forward path and the backward path, the frequency at which the reaction liquid is ejected from the nozzle 21 of the liquid ejecting head H5 is higher than the frequency at which the inks are ejected from the liquid ejecting heads H4 and H6. For these reasons, the amount of mist generated by ejecting the inks from the liquid ejecting heads H4 and H6 is small, and the mist of the inks ejected from the liquid ejecting heads H4 and H6 is less likely to adhere to the ejection surface 120 of the liquid ejecting head H5. Even when the mist of the inks ejected from the liquid ejecting heads H4 and H6 adheres to the ejection surface 120 of the liquid ejecting head H5, the reaction liquid and the ink mist in the nozzle 21 of the liquid ejecting head H5 are less likely to aggregate with each other because the amount of the reaction liquid ejected from the liquid ejecting head H5 is large and the frequency at which the reaction liquid is ejected is high. Therefore, it is not necessary to dispose the liquid ejecting head H that ejects the treatment liquid in the +X direction of the liquid ejecting head H5. In addition, there is a concern that the treatment liquid reacts with the reaction liquid and aggregates with the reaction liquid when the treatment liquid comes into contact with the reaction liquid over a long time. Thus, when the liquid ejecting head H that ejects the treatment liquid is disposed in the +X direction of the liquid ejecting head H5, there is a concern that the mist of the reaction liquid adheres to the liquid ejecting head H that ejects the treatment liquid, or the reaction liquid and the treatment liquid react with each other on the ejection surface 120 of the liquid ejecting head H5 when the wiping member 9 wipes the reaction liquid. Therefore, it is preferable not to dispose the liquid ejecting head H that ejects the treatment liquid in the +X direction of the liquid ejecting head H5. That is, since the liquid ejecting head H is not disposed in the +X direction of the liquid ejecting head H5, the ejection surface 120 of the liquid ejecting head H5 is wiped alone by the wiping member 9. Thus, it is possible to suppress an occurrence of a situation in which the liquid adhering to another ejection surface 120 reacts and aggregates with the reaction liquid on the ejection surface 120 of the liquid ejecting head H5, and to suppress the occurrence of the ejection failure of the nozzle 21 of the liquid ejecting head H5.

The ink having the shortest reaction time with the reaction liquid may be ejected from the liquid ejecting heads H4 and H6 near the liquid ejecting head H5 that ejects the reaction liquid, in the Y-axis direction. In general, the reaction time until the reaction with the reaction liquid is completed differs depending on the color of the ink. Therefore, even when the ink having the shortest reaction time with the reaction liquid is ejected from the nozzle rows L of the liquid ejecting heads H4 and H6, as described above, it is possible to remove an aggregate on the ejection surfaces 120 of the liquid ejecting heads H4 and H6 by the wiping member 9 to which the treatment liquid adheres, and to recover the ejection failure of the nozzle 21. In addition, even when the mist of the reaction liquid adheres to the ejection surfaces 120 of the liquid ejecting heads H1 to H3 and H7 to H9 that are disposed at positions farther than the liquid ejecting heads H4 and H6 when viewed from the liquid ejecting head H5 and eject the liquid that reacts with the reaction liquid, it is possible to make it difficult for the ink to aggregate on the ejection surface 120 by the reaction liquid because the reaction time of the ink ejected from the liquid ejecting heads H1 to H3 and H7 to H9 with the reaction liquid is long.

The ink having the longest reaction time with the reaction liquid may be ejected from the liquid ejecting heads H4 and H6 near the liquid ejecting head H5 that ejects the reaction liquid, in the Y-axis direction. According to this, for example, when an influence range of the mist of the reaction liquid is narrow, the ejection failure of the nozzle 21 is less likely to occur in the liquid ejecting head H5 than the liquid ejecting heads H4 and H6. Thus, the wiping containing the treatment liquid on the liquid ejecting head H5 is unnecessary. Furthermore, it is possible to more easily recover the ejection failure of the liquid ejecting heads H4 and H6 by wiping.

The liquid ejecting head H10 is arranged with the liquid ejecting head H1 along the X-axis, and the liquid ejecting head H13 is arranged with the liquid ejecting head H9 along the X-axis. The nozzle rows La and Lb of the liquid ejecting heads H10 and H13 eject the post-treatment liquid.

As described above, by ejecting the post-treatment liquid from the nozzle rows L of the liquid ejecting heads H10 and H13, it is possible to improve the image quality by applying a large amount of the post-treatment liquid onto the medium S. By ejecting the post-treatment liquid from the liquid ejecting heads H10 and H13 in a pass different from the pass in which the post-treatment liquid is ejected by the liquid ejecting heads H1 and H9, it is possible to shift the time for applying the post-treatment liquid. Therefore, it is possible to suppress the bleeding that occurs by excessively applying the post-treatment liquid within the same pass.

In the present embodiment, the number of nozzle rows L of the liquid ejecting heads H1 and H9 that eject the post-treatment liquid in the first row is smaller than the number of nozzle rows L of the liquid ejecting heads H10 and H13 that eject the post-treatment liquid in the second row. In the present embodiment, the number of nozzle rows L of each of the liquid ejecting heads H1 and H9 that eject the post-treatment liquid is four, whereas the number of nozzle rows L of the liquid ejecting heads H10 and H13 that eject the post-treatment liquid is 8. By relatively increasing the number of nozzle rows L of the liquid ejecting heads H10 and H13 that eject the post-treatment liquid in this manner, it is possible to eject a large amount of the post-treatment liquid in order to improve the image quality.

When the ink, the reaction liquid, and the post-treatment liquid are ejected within the same pass by the head unit U, it is not necessary to apply an excessive post-treatment liquid. Thus, it is possible to reduce the size of the head unit U in the Y-axis direction by disposing the liquid ejecting heads H10 and H13 at positions arranged with the liquid ejecting heads H1 and H9 along the X-axis. That is, the row of the liquid ejecting heads H1 to H9 and the row of the liquid ejecting heads H10 to H13 are arranged along the X-axis, as compared with a head unit in which thirteen liquid ejecting heads H are arranged along the Y-axis. Accordingly, it is possible to reduce the size of the head unit U in the Y-axis direction.

In the present embodiment, a first distance d1 between the liquid ejecting head H4 and the liquid ejecting head H11 in the X-axis direction is shorter than a second distance d2 between the liquid ejecting head H4 and the liquid ejecting head H3 in the Y-axis direction. That is, d1<d2. Here, the first distance d1 and the second distance d2 are distances between the ejection surfaces 120 of the two liquid ejecting heads H, which are wiped by the wiping members 9. By setting the first distance d1 to be shorter than the second distance d2 in this manner, the wiping member 9 can wipe the ejection surface 120 of the liquid ejecting head H4 along the X-axis in a state where the wiping member 9 holds a large amount of the treatment liquid collected when the wiping member 9 wipes the ejection surface 120 of the liquid ejecting head H11.

It is preferable that a third distance d3 between the liquid ejecting head H5 and the liquid ejecting head H4 in the Y-axis direction is longer than the second distance d2. That is, preferably, d3>d2. The third distance d3 is a distance between the ejection surfaces 120 of the two liquid ejecting heads H, similarly to the first distance d1 and the second distance d2. By setting the third distance d3 to be longer than the second distance d2 in this manner, the mist generated by ejection of the reaction liquid from the liquid ejecting head H5 is less likely to adhere to the ejection surface 120 of the liquid ejecting head H4, and thus it is possible to reduce the occurrence of the ejection failure of the nozzles 21 in the liquid ejecting head H4. Further, by setting the second distance d2 to be relatively short, it is possible to improve the landing position accuracy of the ink ejected from the liquid ejecting head H4 and the liquid ejecting head H3 on the medium S, and to improve the image quality.

In the present embodiment, as described above, the liquid ejecting heads H4 to H1 and the liquid ejecting heads H6 to H9 are disposed to be line-symmetrical in the Y-axis direction with the liquid ejecting head H5 as the center. That is, a distance between the liquid ejecting head H5 and each of the liquid ejecting heads H3 to H1 in the Y-axis direction is substantially the same as a distance between the liquid ejecting head H5 and each of the liquid ejecting heads H6 to H9 in the Y-axis direction. Therefore, the first distance d1 is equal to a distance between the liquid ejecting head H6 and the liquid ejecting head H12 in the X-axis direction, and the second distance d2 is equal to a distance between the liquid ejecting head H6 and the liquid ejecting head H7 in the Y-axis direction. The third distance d3 is equal to a distance between the liquid ejecting head H5 and the liquid ejecting head H6 in the Y-axis direction. Therefore, the liquid ejecting heads H5, H6, and H12 also have the same effect as described above.

In the present embodiment, in the Y-axis direction, a distance between the liquid ejecting head H3 and the liquid ejecting head H2, a distance between the liquid ejecting head H2 and the liquid ejecting head H1, a distance between the liquid ejecting head H7 and the liquid ejecting head H8, and a distance between the liquid ejecting head H8 and the liquid ejecting head H9 are the same as the second distance d2. Therefore, it is possible to improve the landing position accuracy of the inks ejected from the liquid ejecting heads H1 to H4 and H6 to H9 on the medium S, and to improve the image quality.

In the present embodiment, in the X-axis direction, a distance between the liquid ejecting head H1 and the liquid ejecting head H10 and a distance between the liquid ejecting head H9 and the liquid ejecting head H13 are the same as the first distance d1. Therefore, it is possible to simultaneously wipe the liquid ejecting head H1 and the liquid ejecting head H10 by the wiping member 9, and to simultaneously wipe the liquid ejecting head H9 and the liquid ejecting head H13 by the wiping member 9. Thus, it is possible to reduce the number of times of the wiping member 9 performing the wiping operation and shorten the time required for maintenance, and it is possible to shorten the printing time.

In addition, in the example described above, the third distance d3 is longer than the second distance d2, but the present embodiment is not particularly limited thereto. The third distance d3 may be the same as the second distance d2.

In the present embodiment, the liquid ejecting heads H4 and H6 correspond to a “first head”, the liquid ejecting heads H3 and H7 correspond to a “second head”, and the liquid ejecting heads H1 and H9 correspond to a “third head”. The liquid ejecting heads H10 and H13 correspond to a “fourth head”. The liquid ejecting head H5 corresponds to a “reaction liquid head”, and the liquid ejecting heads H11 and H12 correspond to a “treatment liquid head”. Among the inks containing the coloring materials, the black ink or the magenta ink corresponds to a “first liquid”, and the yellow ink or the green ink corresponds to a “second liquid”.

### Second Embodiment

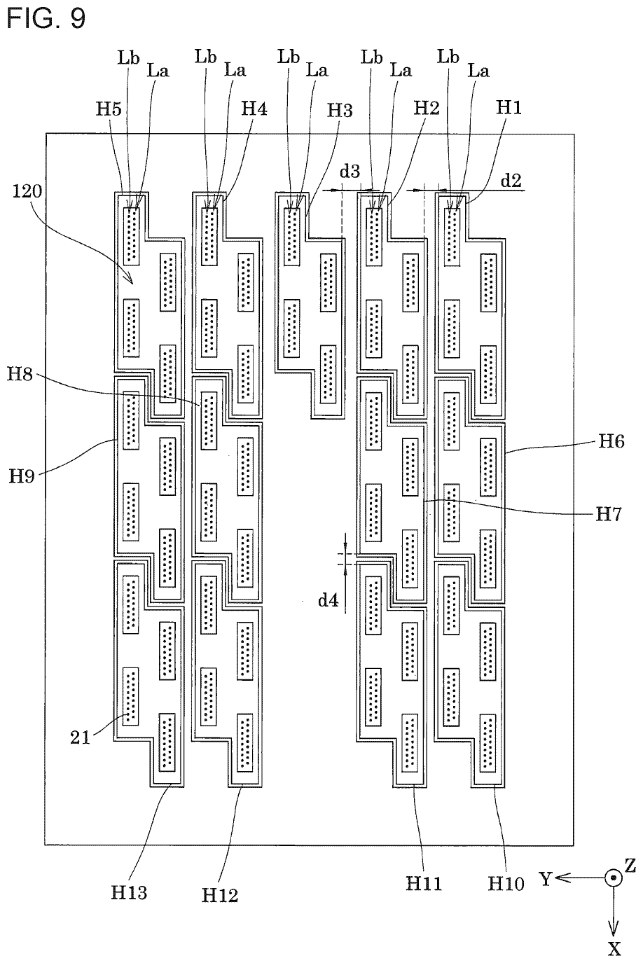

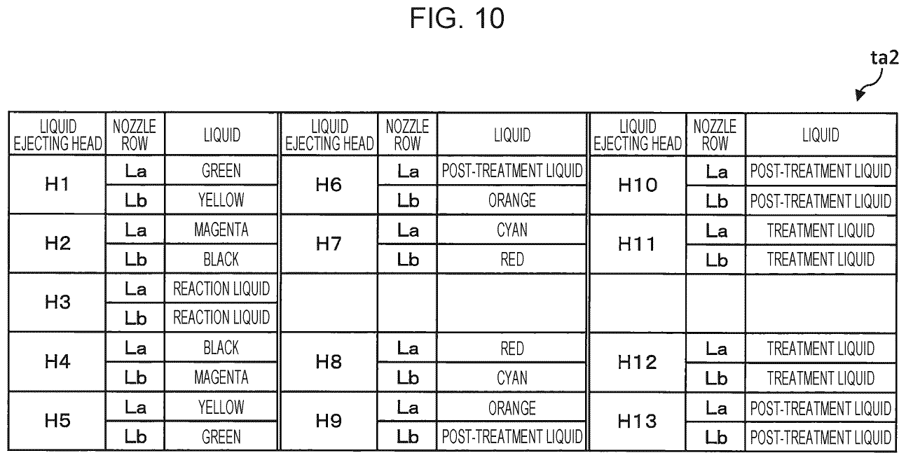

FIG. 9 is a plan view of a head unit U according to a second embodiment of the present disclosure when viewed in the −Z direction. FIG. 10 illustrates a table ta2 showing a correspondence between the disposition of each liquid ejecting head H and a liquid to be ejected. The same reference signs will be given to the same members as those in the above-described embodiment, and the repetitive description thereof will be omitted. Also in the present embodiment, similarly to the embodiment described above, the X-axis is an example of a “first axis”, and the X-axis direction is an example of a “direction along the first axis” or a “transport direction”. The Y-axis is an example of a “second axis”, and the Y-axis direction is an example of a “direction along the second axis”.

As illustrated in FIG. 9, in the head unit U, three rows of a first row, a second row, and a third row are disposed to be arranged along the X-axis. The first row is constituted by five liquid ejecting heads H disposed to be arranged along the Y-axis. The second row is constituted by four liquid ejecting heads H disposed to be arranged along the Y-axis. The third row is constituted by four liquid ejecting heads H disposed to be arranged along the Y-axis direction.

In the present embodiment, the five liquid ejecting heads H constituting the first row are referred to as liquid ejecting heads H1 to H5 in the +Y direction in order. The four liquid ejecting heads H constituting the second row are referred to as liquid ejecting heads H6 to H9 in the +Y direction in order. The four liquid ejecting heads H constituting the third row are referred to as liquid ejecting heads H10 to H13 in the +Y direction in order. When the liquid ejecting heads H1 to H13 are not distinguished from each other, the liquid ejecting heads H1 to H13 are referred to as the liquid ejecting head H below. The first row, the second row, and the third row are disposed to be arranged in the +X direction in this order.

In such a head unit U, the liquid ejecting head H3 is adjacent to the liquid ejecting heads H2 and H4, and the liquid ejecting head H3, and the liquid ejecting heads H2 and H4 are disposed to be arranged along the Y-axis.

The liquid ejecting head H2, the liquid ejecting head H7, and the liquid ejecting head H11 are disposed to be arranged along the X-axis.

The liquid ejecting head H4, the liquid ejecting head H8, and the liquid ejecting head H12 are disposed to be arranged along the X-axis.

As shown in Table ta2 of FIG. 10, in the first row of the head unit U, a nozzle row L of the liquid ejecting head H3 located at the center in the Y-axis direction ejects the reaction liquid.

With respect to the liquid ejecting head H3, nozzle rows L of the liquid ejecting heads H2 and H1 located in the −Y direction and a nozzle row L of the liquid ejecting head H4 and H5 located in the +Y direction eject inks containing coloring materials.

In the second row, a nozzle row Lb of the liquid ejecting head H6, nozzle rows L of the liquid ejecting heads H7 and H8, and a nozzle row La of the liquid ejecting head H9 eject inks containing coloring materials. A nozzle row La of the liquid ejecting head H6 and a nozzle row Lb of the liquid ejecting head H9 eject the post-treatment liquid.

In the third row, nozzle rows L of the liquid ejecting heads H11 and H12 eject the treatment liquid. Nozzle rows L of the liquid ejecting heads H10 and H13 eject the post-treatment liquid.

As described above, since the nozzle row L of the liquid ejecting head H3 ejects the reaction liquid, and the nozzle rows L of the liquid ejecting heads H2 and H4 eject the inks, it is possible to increase the distance in the Y-axis direction between the nozzle row L for ejecting the reaction liquid and the nozzle row L for ejecting the ink, as compared to a case where the reaction liquid and the ink are ejected from the common ejection surface 120. Therefore, it is possible to suppress an occurrence of ejection failure such as clogging of the nozzle 21 or the shift of the flight direction of the liquid from the nozzle 21, which has caused by the aggregates obtained when the reaction liquid and the ink react with each other and are aggregated on the ejection surface 120.

In the first row, the disposition is made such that the liquid ejected from the nozzle rows La and Lb of the liquid ejecting heads H1 and H2 located in the −Y direction of the liquid ejecting head H3 and the liquid ejected from the nozzle rows La and Lb of the liquid ejecting heads H4 and H5 located in the +Y direction of the liquid ejecting head H3 have the same order in the +Y direction and the −Y direction by using the liquid ejecting head H3 as a reference.

Similarly, in the second row, the disposition is made such that the liquid ejected from the nozzle rows La and Lb of the liquid ejecting heads H6 and H7 located in the −Y direction of the liquid ejecting head H3 and the liquid ejected from the nozzle rows La and Lb of the liquid ejecting heads H8 and H9 located in the +Y direction of the liquid ejecting head H3 have the same order in the +Y direction and the −Y direction by using the liquid ejecting head H3 as a reference.

The same applies to the third row.

With such disposition, regardless of the head unit U moving in the +Y direction and in the −Y direction, the ejection order of the reaction liquid, the respective colors of the inks containing the coloring materials, and the post-treatment liquid can be similarly set to have the same order. Therefore, when the head unit performs printing by reciprocating in the Y-axis direction, the order of moving in the +Y direction and ejecting the liquid and the order of moving in the −Y direction and ejecting the liquid are set to be the same. Thus, it is possible to set the overlapping order of the liquids on the medium S to be the same, and to set a difference of time of landing the liquid between different types of liquids to be the same. Therefore, it is possible to suppress the difference in the color due to the difference in a scanning direction and the difference in the degree of aggregation of the ink due to the difference in the scanning direction, and to improve the printing quality.

In the first row, since the liquid ejecting head H3 that ejects the reaction liquid is disposed at the center in the Y-axis direction, both printing when the head unit U moves in the +Y direction and printing when the head unit U moves in the −Y direction are set to have the same order of ejecting the inks containing the coloring materials and the reaction liquid. Thus, it is possible to suppress an occurrence of a color difference due to the moving direction of the head unit U.

In the present embodiment, since the ink containing the coloring material is ejected from the liquid ejecting heads H2 and H4 near the liquid ejecting head H3 that ejects the reaction liquid, as compared with a case where the post-treatment liquid is ejected from the liquid ejecting heads H2 and H4, it is possible to shorten the time until the ink containing the coloring material reacts with the reaction liquid on the medium S. In addition, it is possible to suppress the bleeding of the ink and improve the image quality.

In the second row, the nozzle row La of the liquid ejecting head H6 and the nozzle row Lb of the liquid ejecting head H9 that are located at both end portions in the Y-axis direction eject the post-treatment liquid. Therefore, regardless of whether the head unit U is moved in the +Y direction or the −Y direction, the inks containing the coloring materials can be landed on the medium S by the nozzle rows L of liquid ejecting heads H6 to H9, and then the post-treatment liquid for the inks containing the coloring materials on the medium S can be ejected. Thus, it is not necessary to wastefully reciprocate the head unit U in the Y-axis direction in order to eject the post-treatment liquid. That is, both when the head unit U is moved in the +Y direction and when the head unit U is moved in the −Y direction, ejection can be performed without changing the order of ejection of the inks containing the coloring materials and the post-treatment liquid. Thus, it is possible to shorten the printing time.

Further, in the present embodiment, since the maximum of five liquid ejecting heads H are disposed to be arranged along the Y-axis, it is possible to further reduce the size of the head unit U in the Y-axis direction.

The wiping member 9 relatively moves to the head unit U in the −X direction, whereby the wiping member 9 can continuously wipe the ejection surface 120 of the liquid ejecting head H in the third row, the ejection surface 120 of the liquid ejecting head H in the second row, and the ejection surface 120 of the liquid ejecting head H in the first row. Thus, it is possible to reduce the number of times of the wiping member 9 performing the wiping operation.

The wiping member 9 wipes the ejection surfaces 120 of the liquid ejecting heads H11 and H12, and then wipes the ejection surfaces 120 of the liquid ejecting heads H7 and H8. Then, the wiping member 9 wipes the ejection surfaces 120 of the liquid ejecting heads H2 and H4. At this time, the wiping member 9 wipes the ejection surfaces 120 of the liquid ejecting heads H11 and H12, thereby wiping the ejection surfaces 120 of the liquid ejecting heads H7, H8, H2, and H4 in a state where the treatment liquid adheres to the wiping member 9. Since the treatment liquid contains the softening agent as described above, it is possible to reduce friction with the ejection surface 120. Therefore, it is possible to strongly press the wiping member 9 to which the treatment liquid adheres, against the ejection surfaces 120 of the liquid ejecting heads H2 and H4, and to perform wiping with a relatively strong force. As described above, since the wiping member 9 wipes the ejection surface 120 of the liquid ejecting heads H2 and H4 with a relatively strong force, it is possible to easily recover the ejection failure of the liquid ejecting heads H2 and H4 that are located near the liquid ejecting head H3 that ejects the reaction liquid and in which the ejection failure of the nozzle 21 is likely to occur.

In the present embodiment, in the X-axis direction, a distance between the liquid ejecting head H2 and the liquid ejecting head H7, a distance between the liquid ejecting head H7 and the liquid ejecting head H11, a distance between the liquid ejecting head H4 and the liquid ejecting head H8, and a fourth distance between the liquid ejecting head H8 and the liquid ejecting head H12 are the same as each other. The distance between the liquid ejecting head H2 and the liquid ejecting head H1 and the distance between the liquid ejecting head H4 and the liquid ejecting head H5 in the Y-axis direction correspond to a second distance d2. The distance between the liquid ejecting head H3 and the liquid ejecting head H2 and the distance between the liquid ejecting head H3 and the liquid ejecting head H4 in the Y-axis direction correspond to a third distance d3. Instead of the first distance d1 in the first embodiment described above, the fourth distance d4 in the present embodiment has a relationship with the second distance d2 and the third distance d3, which preferably satisfies the same conditions as those in the first embodiment described above. As a result, the similar effects to those of the first embodiment described above are exhibited.

In the present embodiment, the liquid ejecting heads H2 and H4 correspond to a “first head”, and the liquid ejecting heads H1 and H5 correspond to a “second head”. The liquid ejecting head H3 corresponds to a “reaction liquid head”, and the liquid ejecting heads H11 and H12 correspond to a “treatment liquid head”. The liquid ejecting heads H6 and H9 correspond to a “fourth head”. Among the inks containing the coloring materials, the black ink or the magenta ink corresponds to a “first liquid”, and the yellow ink or the green ink corresponds to a “second liquid”.

### Other Embodiments

Although each embodiment of the present disclosure was described above, the basic configuration of the present disclosure is not limited to the above-described one.

For example, in the first embodiment described above, the nozzle row L of the liquid ejecting head H5 may eject the reaction liquid, and the nozzle row Lb of the liquid ejecting head H4 and the nozzle row La of the liquid ejecting head H6 may eject the post-treatment liquid. In this case, the nozzle row La of the liquid ejecting head H4, the nozzle rows La and Lb of the liquid ejecting heads H7 to H9 and H3 to H1, and the nozzle row Lb of the liquid ejecting head H6 only need to eject the inks containing the coloring materials. In this case, the liquid ejecting heads H4 and H6 correspond to the “first head”, and the post-treatment liquid corresponds to a “first liquid”. Even in such a configuration, the post-treatment liquid reacts and aggregates with the reaction liquid. Thus, it is possible to recover the ejection failure and suppress the ejection failure of the nozzles 21 of the liquid ejecting heads H4 and H6 in a manner that the treatment liquid is ejected from the nozzle rows L of the liquid ejecting heads H11 and H12 adjacent to the liquid ejecting heads H4 and H6 along the X-axis, and the wiping member 9 performs wiping. The same applies to the second embodiment described above.

Furthermore, in the embodiments described above, the driving element that causes the pressure change in the liquid in the pressure chamber 12 was described by using the thin-film type piezoelectric actuator 300. The present disclosure is not particularly limited thereto. As other driving elements, for example, a thick-film type piezoelectric actuator formed by a method such as sticking a green sheet, or a longitudinal vibration type piezoelectric actuator which is obtained by alternately stacking a piezoelectric material and an electrode forming material and which expands and contracts in axial directions can be used. In addition, as the other driving elements, an element in which a heat generating element is disposed in the pressure chamber 12 to eject the liquid from the nozzle 21 by bubbles generated due to the heat of the heat generating element, a so-called electrostatic actuator that generates static electricity between a diaphragm and an electrode, deforms the diaphragm by the electrostatic force, and ejects the liquid from the nozzle 21, and the like can be used.

Further, the present disclosure is intended for a wide range of head units including liquid ejecting heads. Examples of the liquid ejecting head include recording heads such as various ink jet recording heads used in an image recording apparatus such as a printer, and coloring material ejecting heads used for manufacturing color filters in liquid crystal displays and the like. Examples of the liquid ejecting head include an electrode material ejecting head used for forming an electrode such as an organic EL display and a field emission display (FED), and a bioorganic substance ejecting head used for bio-chip manufacturing. The present disclosure can also be applied to a head unit including the above liquid ejecting head, and can also be applied to a liquid ejecting apparatus including such a head unit.

### Supplementary Notes

From the embodiments exemplified above, for example, the following configuration can be ascertained.

According to Aspect 1 that is a preferred aspect, there is provided a head unit that ejects a liquid to a medium while reciprocating along a second axis that is perpendicular to a first axis along a transport direction of the medium, the head unit including a plurality of liquid ejecting heads, in which the plurality of liquid ejecting heads include a first head that ejects a first liquid, a reaction liquid head that ejects a reaction liquid that aggregates the first liquid, and a treatment liquid head that ejects a treatment liquid containing a softening agent, and the first head and the reaction liquid head are adjacent to each other and are arranged along the second axis, and the treatment liquid head is arranged with the first head along the first axis.

In Aspect 2 that is a specific example of Aspect 1, the first liquid is an ink containing a coloring material.

In Aspect 3 that is a specific example of Aspect 2, the first liquid is an ink containing an inorganic pigment.

In Aspect 4 that is a specific example of Aspect 1, the plurality of liquid ejecting heads include a second head that ejects a second liquid that is aggregated by the reaction liquid, the first head and the second head are adjacent to each other and are arranged along the second axis, and a first distance between the first head and the treatment liquid head in the direction along the first axis is shorter than a second distance between the first head and the second head in a direction along the second axis.

In Aspect 5 that is a specific example of Aspect 1, the plurality of liquid ejecting heads include a second head that ejects a second liquid that is aggregated by the reaction liquid, the first head and the second head are adjacent to each other and are arranged along the second axis, and a third distance between the first head and the reaction liquid head in the direction along the second axis is longer than a second distance between the first head and the second head in a direction along the second axis.

In Aspect 6 that is a specific example of Aspect 1, the plurality of liquid ejecting heads include a third head that ejects a post-treatment liquid that is aggregated by the reaction liquid, and the third head is disposed to be arranged with the first head and the reaction liquid head in a direction along the second axis.

In Aspect 7 that is a specific example of Aspect 6, the plurality of liquid ejecting heads include a fourth head that ejects the post-treatment liquid, and the fourth head is disposed to be arranged with the treatment liquid head in the direction along the second axis.

In Aspect 8 that is a specific example of Aspect 7, a number of nozzle rows for ejecting the post-treatment liquid in the third head is smaller than a number of nozzle rows for ejecting the post-treatment liquid in the fourth head.

In Aspect 9 that is a specific example of Aspect 7, the third head ejects an ink that contains a coloring material and is aggregated by the reaction liquid.

In Aspect 10 that is a specific example of Aspect 6, the first head is disposed between the reaction liquid head and the third head.

In Aspect 11 that is a specific example of Aspect 1, the treatment liquid is less likely to aggregate with the reaction liquid than the first liquid.

In Aspect 12 that is a specific example of Aspect 1, each of a shape of an ejection surface of the first head and a shape of an ejection surface of the treatment liquid head includes a first portion, a second portion that is adjacent to the first portion and protrudes from the first portion in the transport direction, and a third portion that is adjacent to the first portion and protrudes from the first portion in a direction opposite to the second portion, a dimension of the second portion in a direction along the second axis is smaller than half a dimension of the first portion in the direction along the second axis, the second portion is located in the direction along the second axis with respect to a first center line that extends in the transport direction and is a center line of the first portion, which passes through a center of the first portion in the direction along the second axis, a dimension of the third portion in the direction along the second axis is smaller than half of the first portion a dimension in the direction along the second axis, the second portion and the third portion are located on opposite sides to interpose the first center line, and a portion of the ejection surface of at least one of the first head and the reaction liquid head overlaps a portion of the ejection surface of the treatment liquid head when viewed in the direction along the second axis.

According to Aspect 13 that is a preferred aspect, a liquid ejecting apparatus includes the head unit according to the above aspects, and a wiping member that wipes an ejection surface of the treatment liquid head and an ejection surface of the first head along the first axis in this order.

What is claimed is:

1. A head unit configured to eject a liquid to a medium while reciprocating along a second axis that is perpendicular to a first axis along a transport direction of the medium, the head unit comprising:
a plurality of liquid ejecting heads, wherein
the plurality of liquid ejecting heads include
a first head configured to eject a first liquid,
a reaction liquid head configured to eject a reaction liquid that aggregates the first liquid, and
a treatment liquid head configured to eject a treatment liquid containing a softening agent,
the first head and the reaction liquid head are adjacent to each other and are arranged along the second axis, and
the treatment liquid head is arranged with the first head along the first axis.

2. The head unit according to claim 1, wherein
the first liquid is an ink containing a coloring material.

3. The head unit according to claim 2, wherein
the first liquid is an ink containing an inorganic pigment.

4. The head unit according to claim 1, wherein
the plurality of liquid ejecting heads include a second head configured to eject a second liquid that is aggregated by the reaction liquid,
the first head and the second head are adjacent to each other and are arranged along the second axis, and
a first distance between the first head and the treatment liquid head in the direction along the first axis is shorter than a second distance between the first head and the second head in a direction along the second axis.

5. The head unit according to claim 1, wherein
the plurality of liquid ejecting heads include a second head configured to eject a second liquid that is aggregated by the reaction liquid,
the first head and the second head are adjacent to each other and are arranged along the second axis, and
a third distance between the first head and the reaction liquid head in a direction along the second axis is longer than a second distance between the first head and the second head in the direction along the second axis.

6. The head unit according to claim 1, wherein
the plurality of liquid ejecting heads include a third head configured to eject a post-treatment liquid that is aggregated by the reaction liquid, and
the third head is disposed to be arranged with the first head and the reaction liquid head in a direction along the second axis.

7. The head unit according to claim 6, wherein
the plurality of liquid ejecting heads include a fourth head configured to eject the post-treatment liquid, and
the fourth head is disposed to be arranged with the treatment liquid head in the direction along the second axis.

8. The head unit according to claim 7, wherein
a number of nozzle rows for ejecting the post-treatment liquid in the third head is smaller than a number of nozzle rows for ejecting the post-treatment liquid in the fourth head.

9. The head unit according to claim 7, wherein
the third head is configured to eject an ink that contains a coloring material and is aggregated by the reaction liquid.

10. The head unit according to claim 6, wherein
the first head is disposed between the reaction liquid head and the third head.

11. The head unit according to claim 1, wherein
the treatment liquid is less likely to aggregate with the reaction liquid than the first liquid.

12. The head unit according to claim 1, wherein
each of a shape of an ejection surface of the first head and a shape of an ejection surface of the treatment liquid head includes
a first portion,
a second portion that is adjacent to the first portion and protrudes from the first portion in the transport direction, and
a third portion that is adjacent to the first portion and protrudes from the first portion in a direction opposite to the second portion,
a dimension of the second portion in a direction along the second axis is smaller than half a dimension of the first portion in the direction along the second axis,
the second portion is located in the direction along the second axis with respect to a first center line that extends in the transport direction and is a center line of the first portion, which passes through a center of the first portion in the direction along the second axis,
a dimension of the third portion in the direction along the second axis is smaller than half a dimension of the first portion in the direction along the second axis,
the second portion and the third portion are located on opposite sides to interpose the first center line, and
a portion of the ejection surface of at least one of the first head and the reaction liquid head overlaps a portion of the ejection surface of the treatment liquid head when viewed in the direction along the second axis.

13. A liquid ejecting apparatus comprising:
the head unit according to claim 1; and
a wiping member that wipes an ejection surface of the treatment liquid head and an ejection surface of the first head along the first axis in this order.
